(19) United States
(12) Patent Application Publication
(10) Pub. No.: US 2010/0150678 A1
(43) Pub. Date: Jun. 17, 2010

(54) METHOD OF BROACHING HARDENED STEEL WORKPIECES WITH DIAMOND-TIPPED TOOLS

(75) Inventors: Leonid C. Lev, West Bloomfield, MI (US); Xingcheng Xiao, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/336,806

(22) Filed: Dec. 17, 2008

(51) Int. Cl. B23Q 11/00

(52) U.S. Cl. 409/131

(57) ABSTRACT

A method of broaching a hardened steel workpiece with diamond-tipped tools includes forming a polycrystalline diamond insert and finish-grinding the polycrystalline diamond insert. The polycrystalline diamond insert is attached to an insert holder of a broach bar. A gear blank formed from steel is heat treated, and then an interior portion of the heat treated gear blank is broached with the broach bar. The broaching may occur in a single pass. Some embodiments of the method may further include forming the polycrystalline diamond insert by electrical discharge machining. Furthermore, finish-grinding the polycrystalline diamond insert may include grinding with a diamond grinding wheel. Attaching the polycrystalline diamond insert to the insert holder of the broach bar may include brazing.

### TECHNICAL FIELD

This disclosure relates to machining of hardened steel.

### BACKGROUND OF THE INVENTION

The process of diamond machining has been historically restricted to a small group of materials which do not cause extremely rapid wear of the diamond tool. This small group of materials includes copper alloys, aluminum alloys, and some nickel-based alloys, as well as certain plastics, crystals and salts. Examples of materials which have been traditionally considered not diamond-machinable are the ferrous materials (i.e. steels and irons), uranium, manganese, nickel, cobalt, titanium, chromium, vanadium, and other materials which readily absorb carbon due to unpaired d-shell electron structure.

The failure of the diamond cutting tool when machining ferrous material is due to the conversion of the surface layer of the diamond tool in contact with the steel from the diamond form of carbon to a graphite carbon form, with the constituents in the steel—for example, titanium, cobalt or nickel—acting as a catalyst for this conversion. This conversion, often referred to as graphitization, causes extremely rapid wear of the diamond cutting tool. For instance, turning steel will wear a diamond tool 10,000 times faster than turning brass.

Broaching is a machining process in which a broach tool with a sharp cutting edge moves across the workpiece, removing the predetermined amount of material. The broaching operation is similar to shaping with multiple teeth. The broach is a long multi-tooth cutting tool with teeth that take successively deeper cuts.

### SUMMARY

A method of broaching a hardened steel workpiece with diamond-tipped tools is provided. The method includes forming a polycrystalline diamond insert and finish-grinding the polycrystalline diamond insert. The polycrystalline diamond insert is attached to an insert holder of a broach bar. A gear blank, formed from steel, is heat treated, and then is broached with the broach bar. The broaching may occur in a single pass.

Some embodiments of the method may further include forming the polycrystalline diamond insert by electrical discharge machining. Furthermore, finish-grinding the polycrystalline diamond insert may include grinding with a diamond grinding wheel. Attaching the polycrystalline diamond insert to the insert holder of the broach bar may include brazing.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic flowchart showing one embodiment of a method of broaching a hardened steel workpiece with diamond-tipped tools; and

FIG. 2 is a schematic, partial close-up, cross-sectional view of a broach bar cutting an interior portion of a hardened steel gear blank in accordance with the method shown in FIG. 1.

### DESCRIPTION OF PREFERRED EMBODIMENTS

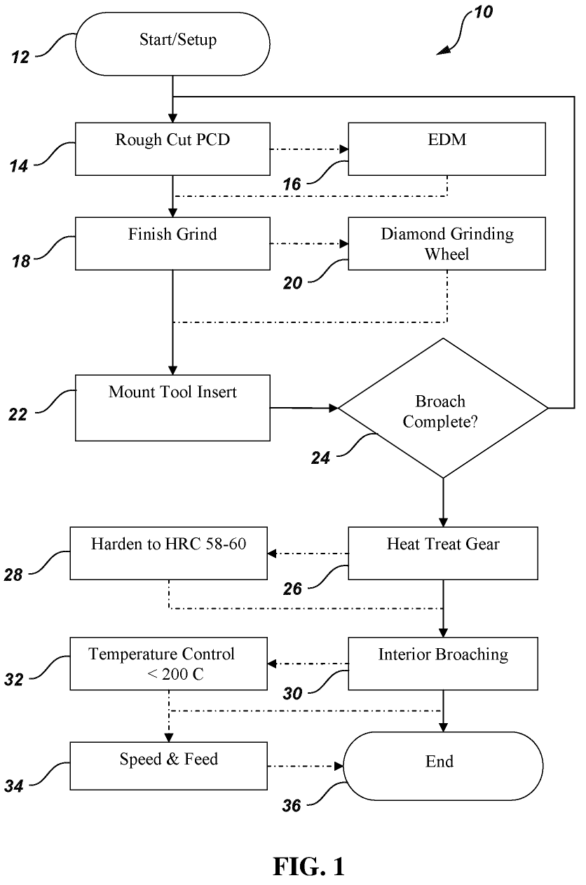

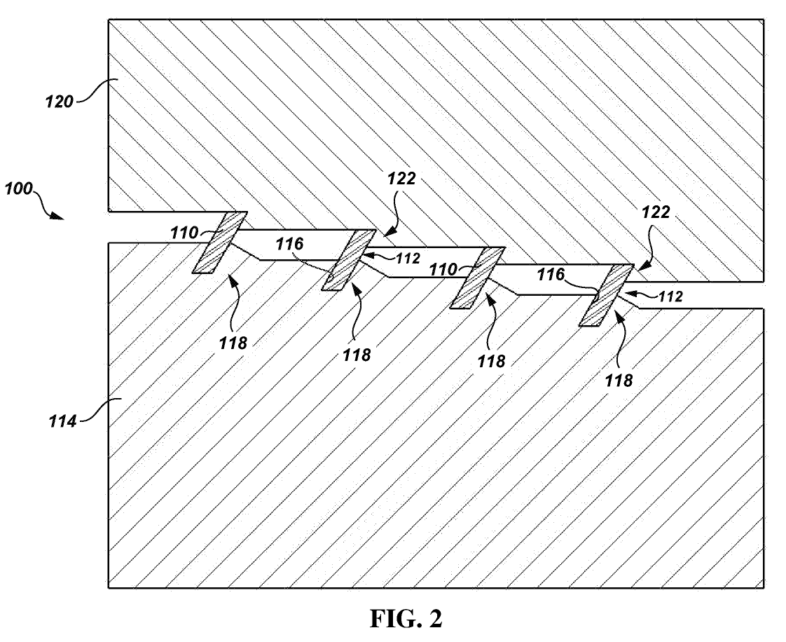

Referring to the drawings, wherein like reference numbers correspond to like or similar components throughout the figures, there is shown in FIG. 1 one embodiment of a method 10 of machining hardened steel with diamond tools. FIG. 2 shows a schematic, cross-sectional, close up view of a portion of the machining interface 100 between the diamond tools and the hardened steel workpiece. Machining interface 100 shows exemplary structure which may be used to execute a portion of the method 10 shown in FIG. 1.

Referring to FIG. 1, and also with reference to FIG. 2 where appropriate, method 10 begins with a start, initialization, and setup step 12. Step 14 includes forming a polycrystalline diamond (PCD) tool insert 110. The PCD tool insert 110 is only rough-formed in step 14, such that it requires further finishing or processing prior to being used for machining hardened steel.

Polycrystalline diamond (PCD) is a synthesized inter-grown mass of randomly orientated diamond particles in a metal matrix. It is produced by sintering together selected diamond particles at high pressure and temperature. The sintering process is rigidly controlled within the diamond stable region and an extremely hard and abrasion resistant structure is produced.

The sintering process begins with premium saw-grade diamond crystals. These crystals are sintered together at temperatures of approximately 1400 degrees Celsius (° C.) and pressures of around 60 kbar in the presence of a liquid metal catalyst. Typically, the diamond is bonded to a tungsten carbide substrate during the same high-temperature, high-pressure process.

Rough forming occurs by bringing the PCD tool insert 110 close the final dimension and shape, but still requiring a finishing operation to reach the final tool configuration. Rough forming may include cutting the tool insert to near-final shape, or the tool insert may be originally molded or created in the near-final shape.

Some embodiments of the method 10 include optional step 16, in which the rough forming process includes cutting by electrical discharge machining (EDM). EDM is a machining method primarily used for hard metals or those that would be impossible to machine with traditional techniques. EDM removes material by a series of rapidly recurring electric arcing discharges between an electrode (the EDM cutting tool) and the workpiece (here, the PCD tool insert 110), in the presence of an energetic electric field. Consecutive sparks produce a series of micro-craters on the work piece and remove material along the cutting path by melting and vaporization.

EDM cutting of the PCD tool insert 110 permits much higher removal rates than forming by conventional tools, such as high speed steel (HSS) or ceramic tools. However, the micro-cratering caused by EDM affects the surface of the tool. The rough-formed PCD tool insert 110 may, therefore, require a subsequent finishing operation if a high-precision tool is needed.

In step 18, the rough-formed PCD tool insert 110 is subjected to a finishing process to complete the PCD tool insert 110. The finishing process used in this embodiment is grinding. The optional step 20 includes finish-grinding the PCD tool insert 110 on a diamond grinding wheel. After the finish-grinding step, the PCD tool insert 110 is substantially complete.

The finished PCD tool insert 110 is attached or mounted to an insert holder 112 of a broach bar 114 in step 22. Using the hard metal substrate of the PCD material, the PCD tool insert 110 is brazed to a face or slot 116 on the insert holder 112 on the broach bar 114. The PCD tool insert 110 is attached to the insert holder 112 to form a single cutting tooth 118 on the broach bar 114. The bulk of the broach bar 114 may be made of tool steel, high speed steel, or another material suitable for machining operations.

Alternatively, several rough-formed tool inserts 110 may be attached to the broach bar 114. The finishing process of step 18 may then be undertaken on all of the tool inserts 110 while already mounted in the broach bar 114. Ordering the process in this way may be beneficial in achieving dimensional correctness of each tool insert 110 relative to the broach bar 114 and also relative to each of the other tool inserts 110.

Steps 14-22 may be repeated until the broach bar 114 is complete. If additional PCD tool inserts 110 are needed to form additional cutting teeth 118 on the broach bar 114, decision step 24 sends method 10 through steps 14-22. A second PCD tool insert 110 is rough formed and then finished in steps 14-20. The second PCD tool insert 110 is then similarly attached, such as by brazing, to a second insert holder 112 on the broach bar 114, to form a second cutting tooth 118 thereon.

Those having ordinary skill in the art will recognize that each of the rough cutting and finishing steps 14 and 18 may incorporate multiple PCD tool inserts 110. Alternatively, the processes may be executed concurrently on multiple PCD tool inserts 110. Therefore, multiple, or all, of the PCD tool inserts 110 may be brazed to multiple inert holders 112 on the broach bar 114, to form multiple cutting teeth 118 in a single attachment step 22. The portion of the machining interface 100 in FIG. 2 shows four cutting teeth 118; however, the broach bar 114 may include more cutting teeth 118.

Upon completion of the broach bar 114, the decision step 24 progresses the method 10 to the preparation and machining of the hardened steel gear, beginning with step 26.

A gear blank 120 is formed without (at least) its interior gear teeth already formed, and is then heat treated in step 26. The gear blank 120 is formed from high-carbon or alloyed steel. Heat treating increases the hardness and wear resistance of the gear. Those having ordinary skill in the art will recognize that the gear blank 120 may be heat treated prior completion of the broach bar 114, and that the method is not limited by the order of production shown in method 10. An internal gear broach cuts internal gear forms. The pattern of its cutting teeth 118 gradually removes stock away at the internal surface of the gear blank 120 (the workpiece,) generating the desired gear profile.

Prior to heat treating, the gear blanks 120 are machined to dimensions leaving at least 0.3 mm of stock per side to be removed after heat treatment. However, the subsequent heat treatment results in heat distortions of the gear blanks 120.

Method 10 uses an alternative process to forming or cutting the interior gear teeth and then heat treating the gear. Heat treating the gear after forming the gear teeth may result in distortions due to the heat treating process. These distortions reduce the precision of the gear teeth, which may require subsequent manufacturing procedures to return the gear teeth to desired precision.

Heat treating the gear blank 120 prior to forming the gear teeth removes the risk of distorting preformed gear teeth. However, heat-treated gears are more difficult to machine than untreated (soft) gears.

Optional step 28 includes carburizing and surface-hardening the gear blank 120 to a Rockwell Hardness C-scale (HRC) value in a range of approximately HRC 58-60. Steel having this level of hardness is extremely difficult to machine, and would result in extremely low durability of cutting tools made of ceramics, HSS, or Cubic boron nitride (CBN).

Following heat treatment of the gear blank 120, the interior gear teeth are cut in step 30. The broach bar 114 having the PCD tool inserts 110 is either pushed or pulled through the center of the gear blank 120. Step 30 may be accomplished using only a single pass of the broach bar 114 through the gear blank 120. The cutting teeth 118 of the broach bar 114 are successively stepped such that each cutting tooth 118 takes a little deeper bite than the cutting tooth 118 that precedes it.

In the view shown in FIG. 2, the broach bar 114 is pulled or pushed from left to right. The broach bar 114 cuts the internal gear teeth to final shape, possible in a single pass, and does so with high precision.

Passing the broach bar 114 through the interior of the gear blank 120 in a single pass—as opposed to a high amplitude reciprocating motion—blocks any lubricant or cooling fluid from reaching many or all cutting interfaces 122 between the material of the gear blank 120 and the PCD tool inserts 110. For example, as viewed in FIG. 2, even if the cutting interface 122 shown on the far right is able to fluidly communicate with cooling fluid, the cutting interface 122 second from the right would be blocked from communication with the cooling fluid. This lack of cooling fluid on the cutting interfaces 122 increases the temperature of the gear blank 120 and also of the individual cutting teeth 118 and PCD tool inserts attached thereto.

The method 10 may include an optional step 32, in which the temperature of the cutting interface 122 between the cutting teeth 118 and the material of gear blank 120 is maintained at or below approximately 500 degrees Celsius. This temperature may be sufficient to avoid graphitization of the PCD tool inserts 110 by the interaction of the steel material from the gear blank 120.

A further optional step 34 machines the interior gear teeth 118 at specific speed and feed rate settings. In one embodiment, these specific settings include a speed of between approximately 6 to 60 meters per minute, and a feed rate per cutting edge of between approximately 10 to 100 micrometers. Method 10 ends at step 36, where the broaching of the internal gear blank is substantially complete and the internal gear forms have been machined.

The cutting speed motion of broaching is accomplished by the linear travel of the broach bar 114 past the work surface of the gear blank 120. Feed in broaching is accomplished by the increased step between the cutting edges of successive teeth 118 on the broach bar 114. Feed rate is actually the feed per tooth 118, and may not be a constant for all the teeth 118. The total material removed in a single pass of the broach bar 114 or the total feed is the cumulative result of all the steps in the tool.

While the best modes and other embodiments for carrying out the claimed invention have been described in detail, those familiar with the art to which this invention relates will recognize various alternative designs and embodiments for practicing the invention within the scope of the appended claims.

1. A method of broaching a hardened steel workpiece with diamond-tipped tools, comprising:
forming a polycrystalline diamond insert;
finish-grinding the polycrystalline diamond insert;
attaching the polycrystalline diamond insert to an insert holder of a broach bar;
heat treating a gear blank formed from steel; and
broaching an interior portion of the heat treated gear blank with the broach bar, wherein said broaching occurs in a single pass.

2. The method of claim 1, wherein forming the polycrystalline diamond insert includes electrical discharge machining.

3. The method of claim 2, wherein finish-grinding the polycrystalline diamond insert includes grinding with a diamond grinding wheel.

4. The method of claim 3, wherein attaching the polycrystalline diamond insert to the insert holder of the broach bar includes brazing.

5. The method of claim 4, wherein attaching the polycrystalline diamond insert to the insert holder of the broach bar occurs prior to the finish-grinding the polycrystalline diamond insert.

6. The method of claim 5, further comprising:
forming a second polycrystalline diamond insert;
finish-grinding the second polycrystalline diamond insert; and
attaching the second polycrystalline diamond insert to a second insert holder of the broach bar.

7. The method of claim 6, wherein broaching the interior portion is characterized by an absence of interaction between the polycrystalline diamond insert and a cooling fluid.

8. The method of claim 7, further comprising, maintaining the polycrystalline diamond insert and the gear blank at or below a temperature of 500 degrees Celsius.

9. The method of claim 8, wherein heat treating the gear blank includes one of carburizing and surface-hardening.

10. The method of claim 9, wherein heat treating the gear blank includes hardening the gear blank to HRC 58-60.

11. The method of claim 10, wherein broaching of the heat treated gear occurs at a speed between approximately 6 to 60 meters per minute and a feed rate between approximately 10 to 100 micrometers between the polycrystalline diamond inserts.

12. A method of broaching a hardened steel workpiece with diamond-tipped tools, comprising:
forming a plurality of polycrystalline diamond inserts;
brazing the plurality of polycrystalline diamond inserts to a plurality of insert holders of a broach bar;
finish-grinding the plurality of polycrystalline diamond insert;
heat treating a gear blank formed from steel; and
broaching an interior portion of the heat treated gear blank with the broach bar.

13. The method of claim 12, wherein broaching the interior portion of the heat treated gear blank occurs in a single pass.

14. The method of claim 13, wherein finish-grinding the plurality of polycrystalline diamond inserts includes grinding with a diamond grinding wheel.

15. The method of claim 14, wherein forming the plurality of polycrystalline diamond inserts includes electrical discharge machining.

16. The method of claim 15, wherein heat treating the gear blank includes one of carburizing and surface-hardening.

17. The method of claim 16, wherein broaching the interior portion is characterized by an absence of interaction between the polycrystalline diamond insert and a cooling fluid.
